(19) United States
(12) Patent Application Publication
(10) Pub. No.: US 2016/0378448 A1
(43) Pub. Date: Dec. 29, 2016

(54) SMART DEPLOYER

(71) Applicant: Microsoft Technology Licensing, LLC, Redmond, WA (US)

(72) Inventor: Prasad Pillutla, Hyderabad (IN)

(21) Appl. No.: 14/751,136

(22) Filed: Jun. 26, 2015

(51) Int. Cl. G06F 9/445; G06F 9/44

(52) U.S. Cl. CPC G06F 8/60; G06F 8/20; G06F 8/31; G06F 9/445

(57) ABSTRACT

Disclosed herein is a system and method for generating an application by a user or architect without them needing to understand how to deploy the application to the cloud or distributed environment. The architect develops a schematic representation of the desired application using a visual drawing program. The resultant diagram is analyzed to determine system requirements, performance requirements and to determine if there are any errors in the diagram. The system then proceeds to script the identified components in the diagram and builds any required connections between the components. Once all of the components are scripted and ready to run the system executes the application. If errors are discovered at this time the system alerts the user and the user can correct the diagram to fix the identified issues. The final product is stored for later execution on the distributed or cloud system

### BACKGROUND

Developing applications for the cloud or other distributed computing systems is both labor intensive and time intensive. The architect or developer of the application needs to have detailed knowledge of both the application and the underlying platform. The architect needs to build each component individually within the platform and then verify the solution meets the required business need of the application. However, this process makes it difficult for applications to be rapidly built and deployed by companies where individuals do not have this extensive level of knowledge about the cloud or distributed computing applications.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for generating an application by a user or architect without them needing to understand how to deploy the application to the cloud or distributed environment. The architect develops a schematic representation of the desired application using a visual drawing program. This sketch of the desired application allows for the user to place specific performance requirements on particular components of the system as well as to define how information is to flow and be stored. All of the user's actions are done without creating a working file.

Once the architecture diagram has been created the diagram is provided to a deployment component. The deployment component analyzes the architecture diagram to determine system requirements, performance requirements and to determine if there are any errors in the diagram. The system then proceeds to script the identified components in the diagram and determines if more than one instance of a component is needed to meet the requirements of the diagram. The system also builds any required connections between the components. These connections may be known or unknown to the user at the time they build the diagram. Once all of the components are scripted and ready to run the system executes the application. If errors are discovered at this time the system alerts the user and the user can correct the diagram to fix the identified issues. The final product is stored for later execution on the distributed or cloud system.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is as block diagram illustrating components of a smart deployer system for creating an architecture diagram and scripting the diagram for execution on a distributed computing system according to one illustrative embodiment.

FIG. 2 illustrates an exemplary architecture drawing according to one illustrative embodiment.

FIG. 3 illustrates a flow diagram illustrating a process for scripting an architecture diagram to form an application according to an illustrative embodiment.

FIG. 4 illustrates a component diagram of a computing device according to one embodiment.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media, but not with computer storage media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

The present disclosure utilizes product architecture, business requirements and telemetry to create and deploy cloud or other distributed services. Currently developers rely on PoCs and manual configurations to create and deploy cloud services to meet their business needs. This process is time intensive and error prone. The present disclosure takes an architecture to the cloud by automating cloud service creation and deployment as per architecture artifacts like UML diagrams. This allows the architect to design the system including the desired operational requirements of the system and no longer concern themselves with the actual construction and configuration of the distributed system that is needed to make the service happen.

Cloud or distributed services are often represented as a series of steps in an architecture diagram. Architects of the various services use programs to assist them in making representations of a flow of a service.

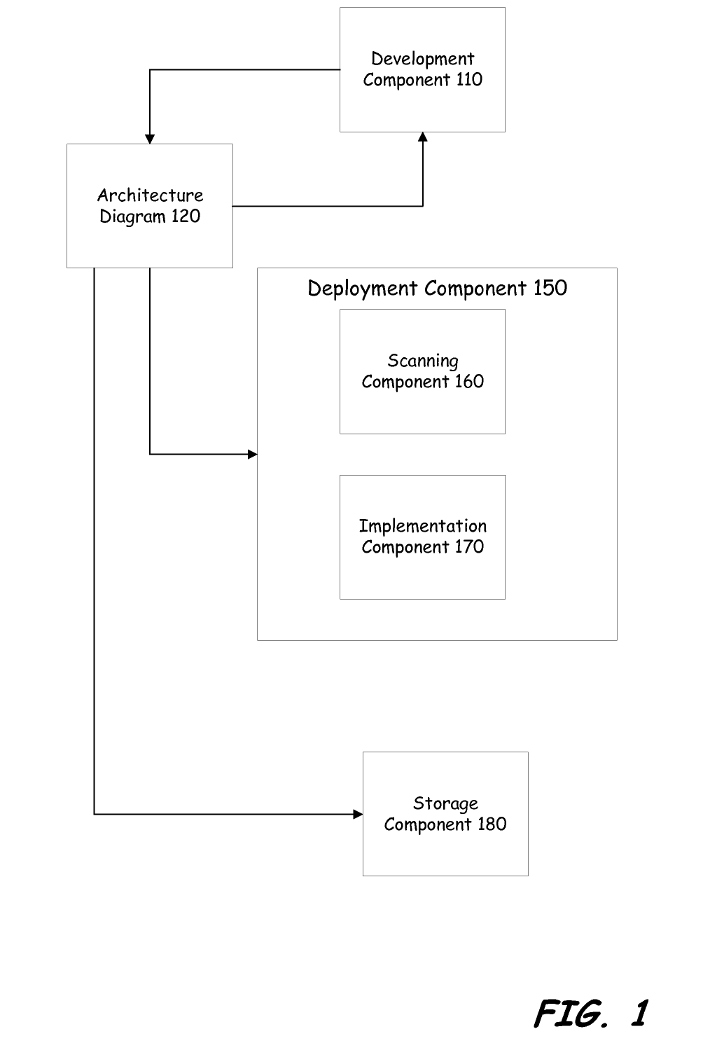

FIG. 1 is a block diagram illustrating components of a smart deployer system 100 according to one illustrative approach for generating an application that can run on a distributed computing system. The details of the exact implementation and operation of the distributed or cloud computing system are not necessary to the present discussion and are therefore omitted. One of ordinary skill in the art would readily understand how these systems work and operate. The smart deployer system 100 includes a development component 110, and a deployment component 150. The deployment component 150 includes a scanning component 160 and an implementation component 170. The smart deployer system 100 may also include a storage component 180.

The development component 110 is a component of the system that permits an architect or other user to define the architecture of the desired service. In one embodiment the development component 110 utilizes a design template such as VISIO to assist the architect in designing the system. However, any other template program can be used that allows the architect to draw or design the service using graphical representations for components, flows and actions. The architect simply diagrams the desired system using the various tools within the development component 110. The architect selects in one approach from a menu of the development component 110 an icon. The icon is representative of an activity in the service. This activity can be for example a specific role (such as a worker role, database, queue, etc), action (such as send a message, or save a file), or function(such as add a column, remove a column, merge two tables, etc.) that is to occur. These icons are associated with known functions and code that can be created by the deployment component 150 during the deployment stage. The architect can then place the icon on the architecture diagram 120 that is displayed. The architect repeats this process for each of the components that they wish to have in the service. The architect also lays out connections between the various components of the service as well as defines the way information or data will flow between the components. The architect also through the development component 110 defines parameters for each of the components in the service, such as scale and performance requirement. For example, if the architect decided that a particular role needed to service 5000 requests per second, then the architect would annotate the particular role with these requirements. The architect can also define through the diagram conditional instances as well. A conditional instance is an instance where depending on a condition different actions may occur. For example a message may be provided to a role that is defined but the architect knows that it may not process correctly. In this instance the architect defines what happens when this particular condition occurs. For example, the message is redirected to another location. These conditional statements are also placed in the architecture diagram 120s as needed. The architect can make a number of architecture diagram 120s for various different services as well as different implementations of the same service. Each of these drawings can be stored for later retrieval when it becomes time to deploy the service on the cloud.

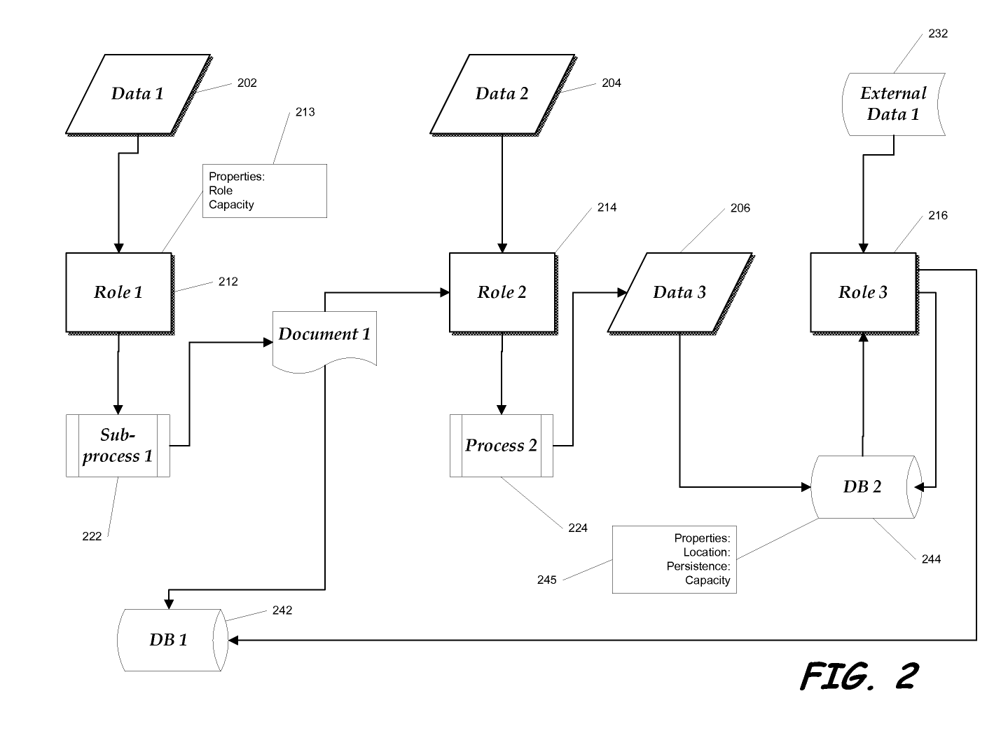

FIG. 2 is a diagrammatic representation of an architecture diagram 120 according to one example. The architecture diagram 120 is a schematic representation of the application. It should be noted that the diagram of FIG. 2 is illustrative of the concepts presented herein and is not representative of an actual service, but of a possible design. The architecture diagram 120 allows the architect to design the service without needing to understand or even know how to cause the various components placed in the diagram are built on the cloud service or how to generate and maintain the connections between the components. FIG. 2 illustrates a process to be followed by the example service. FIG. 2 illustrates data components 202, 204 and 206, role components 212, 214 and 216, process components 222 and 224, external data component 232, and database components 242 and 244. These components are representative of roles and functions that the architect can place into the diagram to create the architecture diagram 120. Each of the components corresponds to known roles that can be generated through scripts on the cloud service. Each of these components has metadata associated with them as well. Items 213 and 245 illustrates examples of metadata that can be associated with a particular role component, such as role 212 and database 244. This metadata can include features such as the role to be performed, the capacity of the role, the location of the component, performance requirements, etc. The architect can drop various components into the diagram and draw the connections that the architect desires between the various components.

Referring back to FIG. 1, the deployment component 150 is a component of the smart deployer system 100 that takes an existing architecture diagram 120 for a service and automatically builds the required components and connections in the cloud to allow the service to operate according the requirements in the architecture diagram 120. As mentioned earlier the deployment component 150 includes a scanning component 160 and an implementation component 170.

The scanning component 160 is a component of the deployment component 150 that analyzes the architecture diagram 120 and determines if there are any changes that need to be made to the drawing such that the desired service will operate properly. The scanning component 160 validates the architecture diagram 120. To validate the architecture diagram 120 the scanning component 160 looks at each icon in the drawing, its related connections as well as any requirements for the component and determines if there are any errors in the drawing. Errors in the drawings can include incorrect components, missing components or incorrect flow. Missing components can occur when the architect or user does not know that a specific component is needed to cause two things to occur. For example in some services in order for a message to be sent to be sent between two different components it must be packaged and or modified. Therefore, a package component would need to be placed in the diagram between when the message is created and it is sent. The scanning component 160 flags each of the errors that it finds in the architecture diagram 120 and then returns the drawing back to the architect. In some embodiments the scanning component 160 returns the diagram after each error it finds. In other embodiments the scanning component 160 waits until it has completed the analysis of the entire drawing. In some embodiments a listing of the errors are provided back. In some embodiments the scanning component 160 can provide suggestions back as to how to correct the errors. If the error is minor the scanning component 160 can optionally fix the error in the drawing and proceed. This can be done in the case of a missing component between two end points. The scanning component 160 can modify on its own the architecture diagram 120 by inserting the required component between the two endpoints.

The implementation component 170 is a component of the deployment system that takes the validated architecture diagram 120 and creates the resources on the cloud as instructed by the architecture diagram 120. The implementation component 170 does not only create the corresponding cloud resources but it also establishes any needed connections needed between them. The implementation component 170 has been programed to understand what each component figure in the architecture diagram 120 is and how to script the corresponding component so that it will work on the distributed computing system. The result of the implementation component is a fully working deployment of the architecture diagram.

Prior to creating the resources the implementation component 170 may receive telemetry data from the distributed service that will host the service represented by the architecture diagram 120. This telemetry data the implementation component 170 is able to understand how the host service will be able to meet any requirements, such as performance, that are in the drawing. The implementation component 170 goes through the architecture diagram 120 and identifies each component that it needs to build for the service. Again each component in the architecture diagram 120 represents a component that the implementation component 170 knows how to script and build. It also reads from the diagram the information (contained in metadata) related to the required performance of that particular component. So for example if the architecture diagram 120 indicated that the particular component needs to be able to accept 5000 requests per second, but the telemetry data indicated that the particular component can only handle 1000 requests per second, the implementation component 170 would create five instances of the particular component as opposed to the single instance that was illustrated in the architecture diagram 120. The implementation component 170 spins up the require number of components for each defined role, action or function defined in the architecture diagram 120.

The implementation component 170 further generates the required connections between each of the components that are created according the instructions laid out in the architecture diagram 120. For example, if the architecture diagram 120 depicted that all message that could not be processed by a particular group of services are to be routed to a storage blob, the implementation component 170 creates create and deploys instances of the particular group of services and storage blob. Once these have been created the implementation component 170 then configures the group of services to route messages to the storage blob in case of failure. All of the configurations required to establish connectivity between group of services and the storage blog are done by the implementation component 170. If the diagram indicated that connectivity should be established with already existing blob, the implementation component 170 would look for details for the already existing blob within the architecture diagram 120. If this information is found in the diagram the implementation component 170 will not create a new blob, but will instead route the messages to that blob.

The implementation component 170 once finished with the deployment of the service updates the architecture diagram 120 with the corresponding details from the deployment. This information is stored for later use when the service is later spun up for operational use. This information can include for example the fact that five instances of a component were needed instead of the one instance that is listed and illustrated in the original architecture diagram 120.

The storage component 180 is a component of the system that holds architecture diagram 120s for later use by the associated cloud or distributed computing system. The storage component 180 receives the validated architecture diagram 120 from the implementation component 170 and stores them. In some approaches the storage component 180 can also receive the architecture diagram 120 form the development component 110. In this approach the storage component 180 can then provide the architecture diagram 120 to the deployment component 150 when the time comes to deploy the underlying service. In some embodiments the storage component 180 may store example or template architecture diagram 120s. These diagrams can be provided to the development component 110 during development to provide the architect with a starting point for a service.

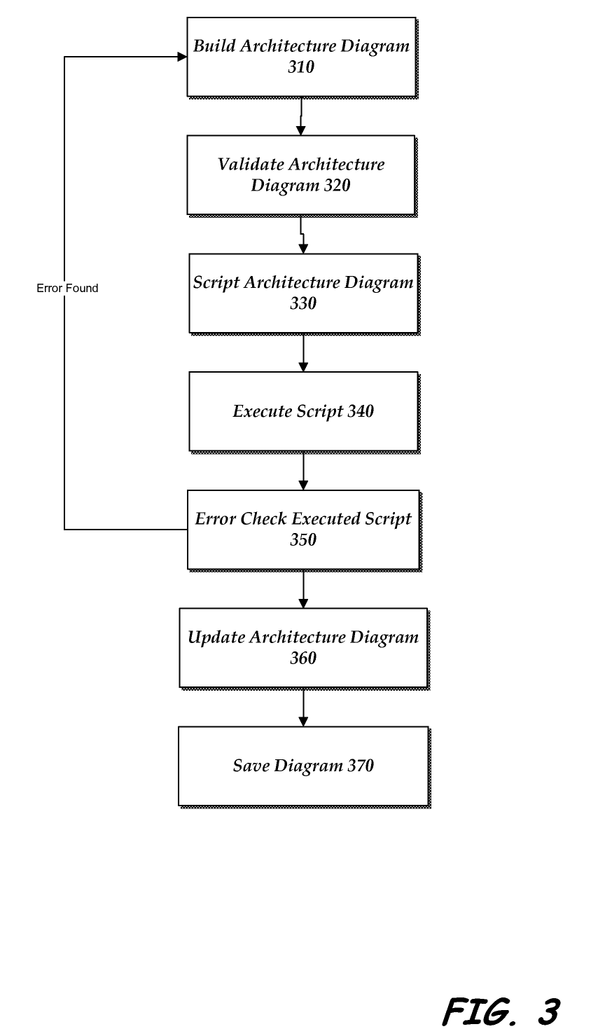

FIG. 3 is flow diagram illustrating a process implemented by the smart deployer system 100 of FIG. 1 above. The process of FIG. 3 allows for a user who is not familiar with how a particular cloud or distributed service operates and generates connections to build and deploy a service simply through the use of an architecture diagram 120.

The user or architect builds an architecture diagram 120. This is illustrated at step 310. The architecture diagram 120 can be created using any program that permits the creation of system diagrams. The architect simply selects the desired role from a menu of roles that have been made available and places it on the diagram. The architect repeats this process for each role, function or activity that they need the service to perform. The architect also at this stage provides performance or other data related to each of the roles in the diagram. This data can include features such as how many request per second the role needs to process, time required to process a request, number of messages that need to be sent, what to do if there is an error at this step, etc. Each of these features is added to the roles. Typically these features are added to the role through the use of a property metadata feature. However, other methods can be used to indicate the features. In some embodiments the architect may start with an existing architecture diagram 120 and modify the diagram as needed. In this way the architect or user can be presented with a set of basic template architecture diagram 120s that help novices begin to build their own services. The completed architecture diagram 120 is then used to deploy the desired system on a cloud or distributed system.

Once the architecture diagram 120 is completed the next step is to begin the deployment of the desired system to the cloud. The process of deploying the system represented by the architecture diagram 120 to the cloud begins by first validating the architecture diagram 120. This is illustrated at step 320. At this step the various roles in the diagram are identified, their performance requirements, their indicated inputs and outputs, their connections to other components, any rules associated with the role, etc. are identified. Each of these features of the role are validated against a set of validation rules for the cloud service. These validation rules may indicate that inputs or outputs expected by the architect in the architecture diagram 120 are not consistent with the desired role or that a connection between two roles cannot happen for a particular reason. It may also be noted that a particular role or function is missing from the architecture diagram 120. These errors can cause the validation process to fail. If the validation process fails the architecture diagram 120 may be returned to the architect to modify the diagram to correct the errors indicated. However, in some embodiments the system can update the diagram automatically to make the necessary corrections. The architect may be notified of these changes made by the system. The architect may be asked to accept these changes. Once the architecture diagram 120 has been determined to be free of errors the process can move forward.

The system then begins to create a deployment and script the architecture diagram 120. This is illustrated at step 330. In one embodiment the system scripts the architecture diagram 120 using PowerShell or http. However, other approaches to scripting the architecture diagram 120 can be used. The scripting process takes each of the identified roles, functions, databases, connections, etc. found in the architecture diagram 120 and prepares then to be executed on the cloud. The system also at this step can received telemetry data from the service. This telemetry data provides performance numbers for the service and assists in determining a number of instances of particular components that are necessary to meet the requirements of the drawings. For example, if a particular role requires the ability to service 5000 requests per second but the telemetry data indicates that a single instance of that role can only service 1000 requests per second the system will know that it will need to spin up at least five instances of that role. The system will cause the scripting to indicate that five instances of that particular role are needed.

Once all of the components and connections are scripted the system proceeds to execute the script on the cloud or distributed service. This is illustrated at step 340. During the running of the scripted version of the architecture diagram 120 any errors that are encountered are reported back to the architect at step 350. If the scripting runs without any errors the architecture diagram 120 is updated with details form the created cloud resources. This is illustrated at step 360. This update includes any of the resources that were created during the scripting as well as the numbers of the specific roles that were created to meet the business requirements as stated in the architecture diagram 120. Again referring to the example where a role needs to service 5000 requests per second, the system automatically created five instances of the role to meet the requirement. The architecture diagram 120 would be updated to indicate that five instances of the role are needed. Following the updating of the architecture diagram 120, the architecture diagram 120 is saved. This is illustrated at step 370.

If there are errors reported back to the architect at step 350 the architect can perform several actions. One approach is that the architect can return to step 310 and update the diagram to address the information that was presented in the error report. If this path is followed the process repeats from step 310 to step 370 until such time as no errors are reported. A second approach is that the architect can review the errors that are reported back and determine that the errors are not errors that should prohibit the service from being deployed or operating and therefore, do not require any changes to the architecture diagram. If this approach is taken the architect can inform the system to ignore the errors and continue with the deployment of the application.

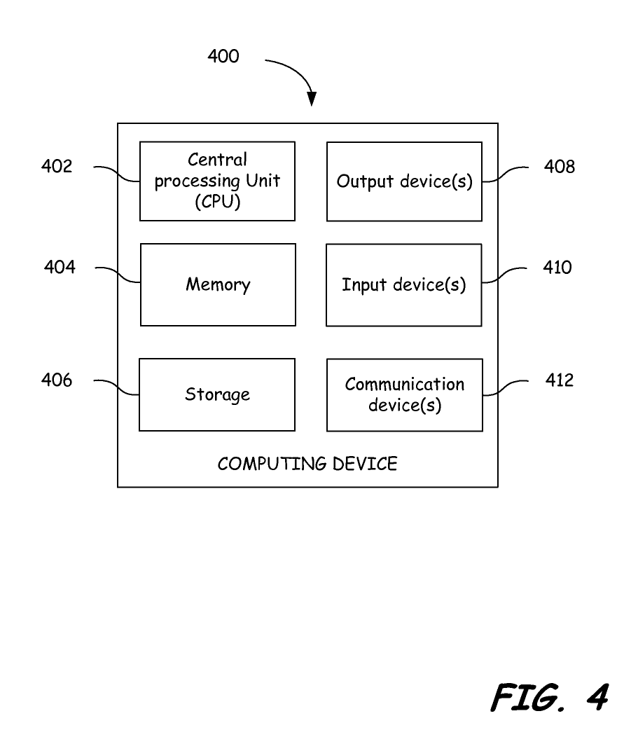

FIG. 4 illustrates a component diagram of a computing device according to one embodiment. The computing device 400 can be utilized to implement one or more computing devices, computer processes, or software modules described herein. In one example, the computing device 400 can be utilized to process calculations, execute instructions, receive and transmit digital signals. In another example, the computing device 400 can be utilized to process calculations, execute instructions, receive and transmit digital signals, receive and transmit search queries, and hypertext, compile computer code, as required by the system of the present embodiments. Further, computing device 400 can be a distributed computing device where components of computing device 400 are located on different computing devices that are connected to each other through network or other forms of connections. Additionally, computing device 400 can be a cloud based computing device.

The computing device 400 can be any general or special purpose computer now known or to become known capable of performing the steps and/or performing the functions described herein, either in software, hardware, firmware, or a combination thereof.

In its most basic configuration, computing device 400 typically includes at least one central processing unit (CPU) 402 and memory 404. Depending on the exact configuration and type of computing device, memory 404 may be volatile (such as RAM), non-volatile (such as ROM, flash memory, etc.) or some combination of the two. Additionally, computing device 400 may also have additional features/functionality. For example, computing device 400 may include multiple CPU's. The described methods may be executed in any manner by any processing unit in computing device 400. For example, the described process may be executed by both multiple CPU's in parallel.

Computing device 400 may also include additional storage (removable and/or non-removable) including, but not limited to, magnetic or optical disks or tape. Such additional storage is illustrated in FIG. 4 by storage 406. Computer storage media includes volatile and nonvolatile, removable and non-removable media implemented in any method or technology for storage of information such as computer readable instructions, data structures, program modules or other data. Memory 404 and storage 406 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 400. Any such computer storage media may be part of computing device 400.

Computing device 400 may also contain communications device(s) 412 that allow the device to communicate with other devices. Communications device(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 400 may also have input device(s) 410 such as keyboard, mouse, pen, voice input device, touch input device, etc. Output device(s) 408 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method for deploying an application to a distributed computing environment comprising:
receiving an architecture diagram having at least one scriptable component;
scanning the architecture diagram to identify components in the architecture diagram;
scripting each identified component, wherein scripting generates a script that enables the identified component to operate on the distributed computing environment; and
executing the scripted components on the distributed computing environment.

2. The method of claim 1 wherein scanning further comprises:
validating the architecture diagram; and
proceeding to scripting when the architecture diagram is successfully validated.

3. The method of claim 2 further comprising:
returning the architecture diagram for edits when the architecture diagram is not successfully validated.

4. The method of claim 2 further comprising:
modifying the architecture diagram when the architecture diagram is not successfully validated; and
revalidating the modified architecture diagram.

5. The method of claim 1 further comprising:
receiving telemetry data from the distributed computing environment.

6. The method of claim 1 wherein scripting further comprises:
building connections between identified components as illustrated in the architecture diagram.

7. The method of claim 1 wherein the architecture diagram includes metadata defining at least one performance property of at least one identified component.

8. The method of claim 6 wherein scripting further comprises:
determining a number of instances of the at least one identified component required to meet the at least one performance property; and
scripting the determined number of instances of the at least one identified component.

9. The method of claim 1 wherein the architecture diagram includes metadata describing at least one conditional action.

10. The method of claim 1 further comprising:
validating a scripted version of the architecture diagram following execution of the scripted components.

11. The method of claim 10 further comprising:
returning a list of errors to an architect when validation of the scripted version of the architecture diagram indicates at least one error.

12. The method of claim 1 further comprising:
storing a scripted version of the architecture diagram.

13. A computing device for deploying an application to a distributed computing system, comprising:
at least one memory and at least one processor that are respectively configured to store and execute instructions, including instructions for causing the computing device to:
present an editor through which a schematic representation of the application is editable, wherein at least one component represented in the schematic representation of the application is scriptable; and
automatically convert the schematic representation of the application into a version of the application that is automatically deployable on the distributed computing environment.

14. The computing device of claim 13, wherein the instructions are also for causing the computing device to:
analyze the schematic representation; and
determine if any changes are to be made to the schematic representation in order to deploy the application on the distributed computing system.

15. The computing device of claim 13, wherein the instructions are also for causing the computing device to:
generate an executable version of the application, including:
identifying components represented in the schematic representation; and
generating executable scripts for identified components represented in the schematic representation.

16. The computing device of claim 15, wherein the instructions are also for causing the computing device to:
generate connections between each of the identified components based on visual connections between the components represented in the schematic representation.

17. The computing device of claim 15, wherein the instructions are also for causing the computing device to:
update the schematic representation with corresponding executable scripts for the identified components.

18. The computing device of claim 13, wherein the instructions are also for causing the computing device to:
receive telemetry data from the distributed computing system, the telemetry data including capacity and performance data for the distributed computing system.

19. The computing device of claim 18, wherein the instructions are also for causing the computing device to:
modify at least a portion of the schematic representation based upon the received telemetry data.

20. A computer readable storage media having computer executable instructions that when executed cause at least one computer having at least one processor to:
receive an architecture diagram having at least one scriptable component;
scan the architecture diagram to identify components in the architecture diagram;
validate the architecture diagram;
return the architecture diagram for edits if the architecture diagram is not successfully validated;
if the architecture diagram is successfully validated, script each identified component, wherein scripting generates a script that enables the identified component to operate on the distributed computing environment;
build connections between identified components as illustrated in the architecture diagram; and
execute the scripted components on the distributed computing environment.
